(19) United States
(12) Patent Application Publication
(10) Pub. No.: US 2013/0093573 A1
(43) Pub. Date: Apr. 18, 2013

(54) SOCKET SYSTEMS FOR AVOIDING ELECTRICAL SHOCKS TO INFANTS LOCATED IN AN ENCLOSED AREA DIVIDED INTO A NUMBER OF SUB-AREAS

(71) Applicant: Yat Wai Edwin Kwong, Causeway Bay (HK)

(72) Inventor: Yat Wai Edwin Kwong, Causeway Bay (HK)

(21) Appl. No.: 13/274,332

(22) Filed: Oct. 16, 2011

(51) Int. Cl. G06K 7/01

(52) U.S. Cl. 340/10.5

(57) ABSTRACT

Socket systems are provided to avoid electrical shocks that may be induced to infants or children staying at home. In one embodiment, a system is provided. The system includes a socket in an area that belongs to a sub-area, wherein the socket is equipped with socket safety features to protect infants from experiencing electrical shocks when certain events occur. The system further includes a fuse associated with the socket; a GPS receiver and a RFID tag associated with an infant; a heavy-duty appliance with high power requirements associated with a GPS receiver; and a low-duty appliance with low power requirements, wherein the appliance is connected to the socket.

### FIELD OF THE INVENTION

This invention is generally related to child safety concerning electrical appliances. Specifically, but not limited to, this invention is related to providing systems for avoiding electrical shocks to infants located in an enclosed area divided into a number of sub-areas.

### BACKGROUND OF THE INVENTION

In many appliances, fuses are commonly included to prevent an excessive current from going through the appliances. The fuses are usually fixed in value, as defined by the amount of electrical current that would cause the fuses to break or blow. When a fuse is broken, the associated electric circuit is no longer connected and thus no current flows through the connected appliances. The broken fuse may either be manually re-enabled or may simply need to be replaced. There is a need, therefore, for dynamic fuse devices. That is, a fuse system wherein the amperage may be adjusted in response to different environmental scenarios.

A fuse is usually broken, when the connecting appliance is powered on and the input current exceeds a given amperage. There is a need, however, to estimate when a fuse may be broken in advance, before the connecting appliance is powered on. There may be indicators that show a fuse would have been broken, if the connecting appliance is powered on. For example, in dangerous environments, such as those which encounter high temperatures and/or high humidity, the likelihood of short-circuiting or a blown fuse is increased. There is a need, therefore, to be able to predict the likelihood of a blown fuse under different environmental conditions.

Electrical sockets and appliances also pose a great danger to infants. Infants unaware of the hazards of touching an electric socket could cause serious injury upon tampering with the socket. Typically, parents use protector plugs in sockets to prevent access by infants to the socket. However, this safety measure precludes the socket from being used for its intended purpose, to power appliances.

In view of the foregoing, there is a need for novel systems and methods of utilizing electrical sockets without compromising the safety of infants which may be present in close proximity to the socket.

### SUMMARY OF THE INVENTION

According to embodiments of the invention, a socket system for avoiding electrical shocks to infants located in an enclosed area divided into a number of sub-areas is provided. In one embodiment, a system is provided. The system includes a socket in an area that belongs to a sub-area, wherein the socket is equipped with socket safety features to protect infants from experiencing electrical shocks when certain events occur. The system further includes a fuse associated with the socket; a GPS receiver and a RFID tag associated with an infant; a heavy-duty appliance with high power requirements associated with a GPS receiver; and a low-duty appliance with low power requirements, wherein the appliance is connected to the socket.

It is, therefore, an objective of the disclosed invention to provide a socket system for allowing full use of electrical sockets without compromising the safety of any infants which may be present in close proximity to the socket.

It is a further objective of the disclosed invention to prevent damage to electrical appliances without sacrificing function or safety.

In accordance with these and other objects which will become apparent hereinafter, the invention will now be described with particular reference to the drawing.

### BRIEF DESCRIPTION OF THE DRAWINGS

FIG. 1 shows a exemplary overview of a socket system according to embodiments of the present invention.

### DETAILED DESCRIPTION

Referring now to the figure, a socket system is provided for avoiding electrical shocks to infants located in an enclosed area divided into a number of sub-areas. The socket 100 is shown powering a heavy duty appliance 110. An infant 200 is shown in close proximity to the socket 100. For the purpose of this specification, the infant 200 is considered to be occupying the same “sub-area” as the socket 100. Furthermore, for the purpose of this specification, an infant 200 is in close proximity to a socket 100 when the infant is within range of being able to touch the socket. Thus, this measurement of distance is no more than a couple a feet.

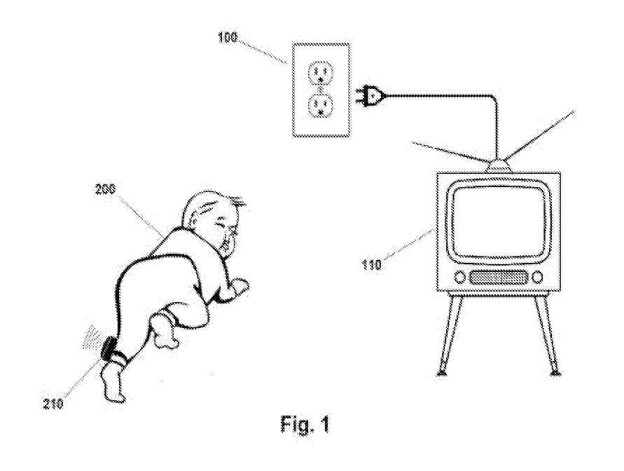

A GPS receiver and Radio-Frequency Identification Tag 210 is shown affixed to the infant's 200 ankle. A Radio-Frequency Identification (hereinafter “RFID”) tag is a means of near field communication through which radio waves are used to by an RFID transmitter to detect and identify nearby RFID receivers or tags. A GPS or Global Positioning System receiver uses satellites to determine the specific location of the receiver. FIG. 1 shows the GPS receiver and RFID tag 210 affixed to the ankle of an infant 200, however, it is envisioned that the tag may be associated with the infant by any reasonable means.

Referring still to FIG. 1, a socket system for avoiding electrical shocks to infants located in an enclosed area divided into a number of sub-areas is provided. The systems components include a socket located in a sub-area, a fuse associated with the socket, a GPS receiver and a RFID tag associated with an infant, a heavy-duty appliance with high power requirements associated with a GPS receiver, a low-duty appliance with low power requirements, a processor; and a memory storage device. The socket is equipped with socket safety features to protect infants from experiencing electrical shocks when certain events occur.

The memory stores instructions that cause the processor to execute a method. The method proceeds along the following steps. First, it is detected whether a triggering event has occurred. The triggering event may be the occurrence of one or more of the following events: a) an infant approaching the socket; b) a heavy-duty appliance being connected to a socket that is near an infant; and/or c) a low-duty appliance being connected to a socket that is in a dangerous environment. A dangerous environment, for the purpose of this specification, may be defined as an area which encounters a high degree of humidity and/or high temperatures. Upon detecting that one or more of the triggering events has occurred, a socket safety feature is enabled.

The socket safety feature engages first by adjusting the fuse value associated with the fuse of the socket such that the electric currents going through the socket can be controlled at different levels. The fuse value is usually a number in amps. The higher the amperage, the greater the electrical current that the fuse can withstand without breaking. The different levels of electrical currents running through the socket may be one of three levels: a) a lower security level, wherein the fuse value is set to a lower threshold value in comparison with a normal operating value; b) a higher security level, wherein the fuse value is set to a threshold value lower than that associated with the lower security level; and c) an absolute security level, wherein the fuse value is set to zero. The next step in enabling the safety feature involves detecting if the infant is in close physical proximity to the socket using data provided from the GPS receiver and the RFID tag associated with the infant. Then, adjusting the fuse value of the fuse of the socket accordingly based on detected proximity of the infant to the socket. The method proceeds by detecting if the infant is moving away from the socket, using data provided from the GPS receiver and the RFID tag associated with the infant. Then, upon detecting that infant is moving away from the socket, returning the fuse value to the normal value.

In another embodiment of the present invention, a socket system is disclosed. the systems components include a socket located in a sub-area, a fuse associated with the socket, a GPS receiver and a RFID tag associated with an infant, a heavy-duty appliance with high power requirements associated with a GPS receiver, a low-duty appliance with low power requirements, a processor; and a memory storage device. The socket is equipped with socket safety features to protect infants from experiencing electrical shocks when certain events occur.

The memory stores instructions that cause the processor to execute a method. The method proceeds along the following steps. First, it is detected whether a triggering event has occurred. The triggering event may be the occurrence of one or more of the following events: a) an infant approaching the socket; b) a heavy-duty appliance being connected to a socket that is near an infant; and/or c) a low-duty appliance being connected to a socket that is in a dangerous environment. Upon detecting that one or more of the triggering events has occurred, a socket safety feature is enabled.

The socket safety feature engages first by adjusting the fuse value associated with the fuse of the socket such that the electric currents going through the socket can be controlled at different levels. The fuse value is usually a number in amps. The higher the amperage, the greater the electrical current that the fuse can withstand without breaking. The different levels of electrical currents running through the socket may be one of three levels: a) a lower security level, wherein the fuse value is set to a lower threshold value in comparison with a normal operating value; b) a higher security level, wherein the fuse value is set to a threshold value lower than that associated with the lower security level; and c) an absolute security level, wherein the fuse value is set to zero. The method proceeds by entering into the lower security level, upon detection that the infant is approaching the socket. Next, the system detects if the infant is in close physical proximity to the socket using data provided from the GPS receiver and the RFID tag associated with the infant, and enters into the absolute security level upon detection thereof. Then, the systems detects if the infant is moving away from the socket using data provided by the GPS receiver and the RFID tag associated with the infant, and returning the fuse value to the normal value upon detection thereof.

In yet another embodiment of the present invention, a socket system is disclosed. the systems components include a socket located in a sub-area, a fuse associated with the socket, a GPS receiver and a RFID tag associated with an infant, a heavy-duty appliance with high power requirements associated with a GPS receiver, a low-duty appliance with low power requirements, a processor; and a memory storage device. The socket is equipped with socket safety features to protect infants from experiencing electrical shocks when certain events occur.

The memory stores instructions that cause the processor to execute a method. The method proceeds along the following steps. First, it is detected whether a triggering event has occurred. The triggering event may be the occurrence of one or more of the following events: a) an infant approaching the socket; b) a heavy-duty appliance being connected to a socket that is near an infant; and/or c) a low-duty appliance being connected to a socket that is in a dangerous environment. Upon detecting that one or more of the triggering events has occurred, a socket safety feature is enabled.

The socket safety feature engages first by adjusting the fuse value associated with the fuse of the socket such that the electric currents going through the socket can be controlled at different levels. The fuse value is usually a number in amps. The higher the amperage, the greater the electrical current that the fuse can withstand without breaking. The different levels of electrical currents running through the socket may be one of three levels: a) a lower security level, wherein the fuse value is set to a lower threshold value in comparison with a normal operating value; b) a higher security level, wherein the fuse value is set to a threshold value lower than that associated with the lower security level; and c) an absolute security level, wherein the fuse value is set to zero. The method proceeds by entering into the higher security level, upon detection that the low-duty appliance has been connected to a socket that is in a dangerous environment. Next, the system detects if the infant is in close physical proximity to the socket using data provided from the GPS receiver and the RFID tag associated with the infant, and enters into the absolute security level upon detection thereof. Then, the systems detects if the infant is moving away from the socket using data provided by the GPS receiver and the RFID tag associated with the infant, and returning the fuse value to the normal value upon detection thereof.

In still another embodiment of the present invention, a socket system is disclosed. the systems components include a socket located in a sub-area, a fuse associated with the socket, a GPS receiver and a RFID tag associated with an infant, a heavy-duty appliance with high power requirements associated with a GPS receiver, a low-duty appliance with low power requirements, a processor; and a memory storage device. The socket is equipped with socket safety features to protect infants from experiencing electrical shocks when certain events occur.

The memory stores instructions that cause the processor to execute a method. The method proceeds along the following steps. First, it is detected whether a triggering event has occurred. The triggering event may be the occurrence of one or more of the following events: a) an infant approaching the socket; b) a heavy-duty appliance being connected to a socket that is near an infant; and/or c) a low-duty appliance being connected to a socket that is in a dangerous environment. Upon detecting that one or more of the triggering events has occurred, a socket safety feature is enabled.

The socket safety feature engages first by adjusting the fuse value associated with the fuse of the socket such that the electric currents going through the socket can be controlled at different levels. The fuse value is usually a number in amps. The higher the amperage, the greater the electrical current that the fuse can withstand without breaking. The different levels of electrical currents running through the socket may be one of three levels: a) a lower security level, wherein the fuse value is set to a lower threshold value in comparison with a normal operating value; b) a higher security level, wherein the fuse value is set to a threshold value lower than that associated with the lower security level; and c) an absolute security level, wherein the fuse value is set to zero. The method proceeds by entering into the higher security level, upon detection that the heavy-duty appliance has been connected to a socket that is near the infant. Next, the system detects if the infant is in close physical proximity to the socket using data provided from the GPS receiver and the RFID tag associated with the infant, and enters into the absolute security level upon detection thereof. Then, the systems detects if the infant is moving away from the socket using data provided by the GPS receiver and the RFID tag associated with the infant, and returning the fuse value to the normal value upon detection thereof.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. A socket system for avoiding electrical shocks to infants located in an enclosed area divided into a number of sub-areas, comprising:
a socket located in a sub-area, wherein the socket is equipped with socket safety features to protect infants from experiencing electrical shocks when certain events occur;
a fuse associated with the socket;
a GPS receiver and a RFID tag associated with an infant;
a heavy-duty appliance with high power requirements associated with a GPS receiver;
a low-duty appliance with low power requirements, wherein the appliance is connected to the socket;
a processor; and
a memory storage device, the memory storing instructions that cause the processor to execute a method, the method comprising:
detecting if a triggering event has occurred, the triggering event selected from the group consisting of:
a) when the infant is approaching to the socket;
b) when the heavy-duty appliance is connected to a socket that is near the infant; and
c) when the low-duty appliance is connected to a socket that is in a dangerous environment, such as high humidity and high temperature;
upon detecting that one or more of the triggering events has occurred, enabling a socket safety feature, wherein the socket safety feature includes:
adjusting a fuse value associated with the fuse of the socket, so that electrical currents going through the socket can be controlled at different levels, the different levels selected from the group consisting of:
a) a lower security level, wherein the fuse value is set to a lower threshold value in comparison with a normal operating value;
b) a higher security level, wherein the fuse value is set to a threshold value lower than that associated with the lower security level; and
c) an absolute security level, wherein the fuse value is set to zero;
detecting if the infant is in close physical proximity to the socket using data provided from the GPS receiver and the RFID tag associated with the infant;
adjusting the fuse value of the fuse of the socket accordingly based on detected proximity of the infant to the socket;
detecting if the infant is moving away from the socket, using data provided from the GPS receiver and the RFID tag associated with the infant; and
upon detecting that infant is moving away from the socket, returning the fuse value to the normal value.

2. A socket system for avoiding electrical shocks to infants located in an enclosed area divided into a number of sub-areas, comprising
a socket located a sub-area, wherein the socket is equipped with socket safety features to protect infants from experiencing electrical shocks when certain events occur;
a fuse associated with the socket;
a GPS receiver and a RFID tag associated with an infant;
a heavy-duty appliance with high power requirements associated with a GPS receiver;
a low-duty appliance with low power requirements, wherein the appliance is connected to the socket;
a processor; and
a memory storage device, said memory storing instructions that cause the processor to execute a method, the method comprising:
detecting if a triggering event has occurred, the triggering event selected from the group consisting of:
a) when the infant is approaching to the socket;
b) when the heavy-duty appliance is connected to a socket that is near the infant; and
c) when the low-duty appliance is connected to a socket that is in a dangerous environment, such as high humidity and high temperature;
upon detecting that one or more of the triggering events has occurred, enabling a socket safety feature, wherein the socket safety feature includes:
adjusting a fuse value associated with the fuse of the socket, so that electrical currents going through the socket can be controlled at different levels, the different levels selected from the group consisting of:
a) a lower security level, wherein the fuse value is set to a lower threshold value in comparison with a normal operating value;
b) a higher security level, wherein the fuse value is set to a threshold value lower than that associated with the lower security level; and
c) an absolute security level, wherein the fuse value is set to zero;
entering into the lower security level, upon detection that the infant is approaching the socket;
detecting if the infant is in close physical proximity to the socket using data provided from the GPS receiver and the RFID tag associated with the infant, and entering into the higher security level upon detection thereof; and
detecting if the infant is moving away from the socket using data provided by the GPS receiver and the RFID tag associated with the infant, and returning the fuse value to the normal value upon detection thereof.

3. A socket system for avoiding electrical shocks to infants located in an enclosed area divided into a number of sub-areas, comprising
a socket located a sub-area, wherein the socket is equipped with socket safety features to protect infants from experiencing electrical shocks when certain events occur;
a fuse associated with the socket;
a GPS receiver and a RFID tag associated with an infant;
a heavy-duty appliance with high power requirements associated with a GPS receiver;
a low-duty appliance with low power requirements, wherein the appliance is connected to the socket;
a processor; and
a memory storage device, said memory storing instructions that cause the processor to execute a method, the method comprising:
detecting if a triggering event has occurred, the triggering event selected from the group consisting of:
a) when the infant is approaching to the socket;
b) when the heavy-duty appliance is connected to a socket that is near the infant; and
c) when the low-duty appliance is connected to a socket that is in a dangerous environment;
upon detecting that one or more of the triggering events has occurred, enabling a socket safety feature, wherein the socket safety feature includes:
adjusting a fuse value associated with the fuse of the socket, so that electrical currents going through the socket can be controlled at different levels, the different levels selected from the group consisting of:
a) a lower security level, wherein the fuse value is set to a lower threshold value in comparison with a normal operating value;
b) a higher security level, wherein the fuse value is set to a threshold value lower than that associated with the lower security level; and
c) an absolute security level, wherein the fuse value is set to zero;
entering into the higher security level, upon detection that the low-duty appliance has been connected to a socket that is in a dangerous environment;
detecting if the infant is in close physical proximity to the socket using data provided from the GPS receiver and the RFID tag associated with the infant, and entering into the absolute security level upon detection thereof; and
detecting if the infant is moving away from the socket using data provided by the GPS receiver and the RFID tag associated with the infant, and returning the fuse value to the normal value upon detection thereof.

4. The socket system of claim 3, wherein the method further comprises the following steps entering into the higher security level, upon detection that the heavy-duty appliance has been connected to a socket that is near the infant;
detecting if the infant is in close physical proximity to the socket using data provided from the GPS receiver and the RFID tag associated with the infant, and entering into the absolute security level upon detection thereof; and
detecting if the infant is moving away from the socket using data provided by the GPS receiver and the RFID tag associated with the infant, and returning the fuse value to the normal value upon detection thereof.
